(19) United States
(12) Patent Application Publication
(10) Pub. No.: US 2024/0184069 A1
(43) Pub. Date: Jun. 6, 2024

(54) OPTICAL FIBER ROLLABLE RIBBON HAVING LOW YOUNG'S MODULUS BONDING MATRIX MATERIAL

(71) Applicant: OFS Fitel LLC, NORCROSS, GA (US)

(72) Inventors: Heng Ly, Stone Mountain, GA (US); Annabelle J Scarpaci, Douglasville, GA (US); Peter A Weimann, Atlanta, GA (US)

(73) Assignee: OFS Fitel LLC, NORCROSS, GA (US)

(21) Appl. No.: 18/286,407

(22) PCT Filed: Aug. 30, 2021
(86) PCT No.: PCT/US21/48129

§ 371 Date: Oct. 11, 2023

Related U.S. Application Data
(60) Provisional application No. 63/174,125, filed on Apr. 13, 2021.

(51) Int. Cl. G02B 6/44

(52) U.S. Cl. CPC G02B 6/4403

(57) ABSTRACT

Embodiments of the invention include an optical fiber ribbon having a low Young's modulus bonding matrix material. The optical fiber ribbon includes a plurality of optical fibers arranged adjacent to one another in a linear array. The optical fiber ribbon also includes a plurality of bonding matrix material portions applied to at least a portion of the outer surface of at least two adjacent optical fibers. The bonding matrix material portions have a low Young's modulus. Also, the plurality of bonding matrix material portions are applied to at least a portion of the outer surface of at least two adjacent optical fibers in such a way that the linear array of optical fibers forms a partially bonded optical fiber ribbon.

### STATEMENT REGARDING RELATED APPLICATIONS

This patent application claims priority under 35 U.S.C. § 119(e) to U.S. Provisional Patent Application Ser. No. 63/174,125, filed on Apr. 13, 2021, entitled, “Low Modulus Matrix in Rollable Ribbon,” the entire contents of which are hereby incorporated by reference.

### BACKGROUND OF THE INVENTION

### Field of Invention

The invention relates to optical fiber rollable ribbons. More particularly, the invention relates to optical fiber rollable ribbons having low Young's modulus bonding matrix material.

### Description of Related Art

An optical fiber ribbon comprises two or more parallel optical fibers that are joined together along their lengths. A material commonly referred to as a matrix or bonding matrix adheres the fibers together. In a “flat” or “encapsulated” optical fiber ribbon, the parallel optical fibers may be fully encapsulated within the bonding matrix material.

In a partially-bonded optical fiber ribbon, also referred to as a rollable ribbon or rollable ribbon unit, the optical fibers forming the optical fiber ribbon are not bonded with matrix material over their entire length. Rather, the optical fibers are bonded intermittently with matrix material, thus allowing the optical fiber ribbon to be folded or rolled into an approximately cylindrical shape, allowing for better filling of a circular cable, resulting in more optical fibers included in a given cable diameter compared to optical fiber cables with conventional fully bonded ribbon structures.

However, with conventional partially-bonded optical fiber ribbons, the lack of a uniform bonding matrix material fully covering the entire portion of each optical fiber can cause one or more of the optical fibers to be relatively sensitive to optical signal transmission losses. That is, conventional bonding matrix material applied intermittently to optical fibers within a rollable ribbon can induce external stress on one or more of the optical fibers, causing unwanted optical signal transmission losses.

### SUMMARY OF THE INVENTION

The invention is embodied in an optical fiber ribbon having a low Young's modulus bonding matrix material. The optical fiber ribbon includes a plurality of optical fibers arranged adjacent to one another in a linear array. The optical fiber ribbon also includes a plurality of bonding matrix material portions applied to at least a portion of the outer surface of at least two adjacent optical fibers. The bonding matrix material portions have a low Young's modulus. Also, the plurality of bonding matrix material portions are applied to at least a portion of the outer surface of at least two adjacent optical fibers in such a way that the linear array of optical fibers forms a partially bonded optical fiber ribbon.

### BRIEF DESCRIPTION OF THE DRAWINGS

FIG. 1 is a perspective view of a partially bonded optical fiber ribbon or rollable ribbon, according to embodiments of the invention;

FIG. 2 is a top view of another partially bonded optical fiber ribbon or rollable ribbon, according to embodiments of the invention;

FIG. 3A is a perspective view of a partially bonded optical fiber ribbon or rollable ribbon, prior to being rolled, according to embodiments of the invention;

FIG. 3B is a perspective view of the partially bonded optical fiber ribbon or rollable ribbon of FIG. 3A, after being rolled, according to embodiments of the invention;

FIG. 4 is a graph of transmission losses on a ribbon spool for a partially bonded optical fiber ribbon having a relatively low Young's modulus boding matrix material according to embodiments of the invention and for a partially bonded optical fiber ribbon having a conventional, relatively high Young's modulus bonding matrix material;

FIG. 5 is a graph of transmission losses for a partially bonded optical fiber ribbon having a relatively low Young's modulus bonding matrix material according to embodiments of the invention, after being cabled, and for a partially bonded optical fiber ribbon having a conventional, relatively high Young's modulus bonding matrix material, after being cabled;

FIG. 6A is a perspective view of an optical fiber cable or loose-tube cable structure containing a plurality of partially bonded optical fiber ribbons in which the intermittently applied bonding matrix material portion of the partially bonded optical fiber ribbons is a low Young's modulus bonding matrix material, according to embodiments of the invention; and

FIG. 6B is a cross-sectional view of the optical fiber cable or loose-tube cable structure of FIG. 6A, containing a plurality of partially bonded optical fiber ribbons in which the intermittently applied bonding matrix material portion of the partially bonded optical fiber ribbons is a low Young's modulus bonding matrix material, according to embodiments of the invention.

### DETAILED DESCRIPTION OF EXEMPLARY EMBODIMENTS

In the following description like reference numerals indicate like components to enhance the understanding of the invention through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the invention.

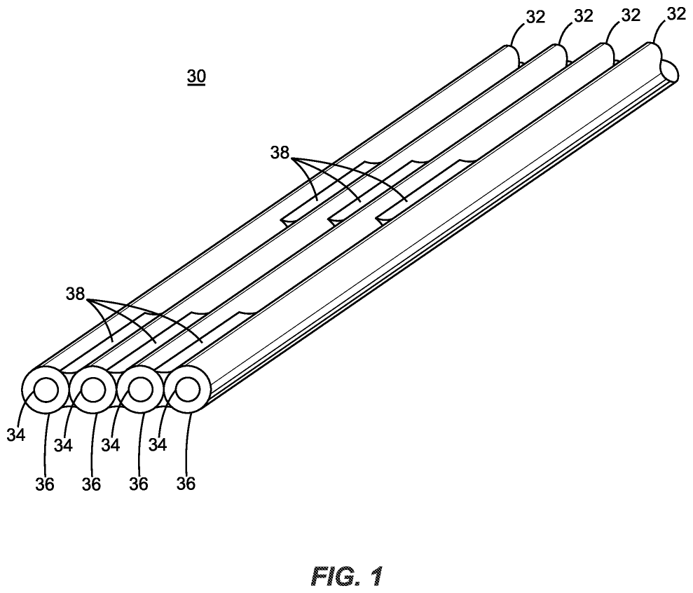

FIG. 1 is a perspective view of a 4-fiber partially bonded optical fiber ribbon or rollable ribbon 30. The optical fiber ribbon 30 includes a plurality of optical fibers 32 linearly arranged as a ribbon, with each optical fiber 32 having a glass portion 34 and a coating portion 36. In optical fiber ribbon 30, portions of the periphery of the optical fibers 32 are intermittently covered with a bonding or ribbon matrix material portion 38. As shown, the matrix material portions 38 are applied (uniformly or non-uniformly) along and bond to various portions of the outer surface of the optical fibers 32 between adjacent optical fibers 32. The matrix material portions 38 are applied across portions of adjacent optical fibers in such a way that the bonding matrix material is dense enough to allow the resulting partially bonded optical fiber ribbon to be able to lay substantially flat, but also sparse enough to allow the resulting partially bonded optical fiber ribbon to be rolled into a substantially circular shape.

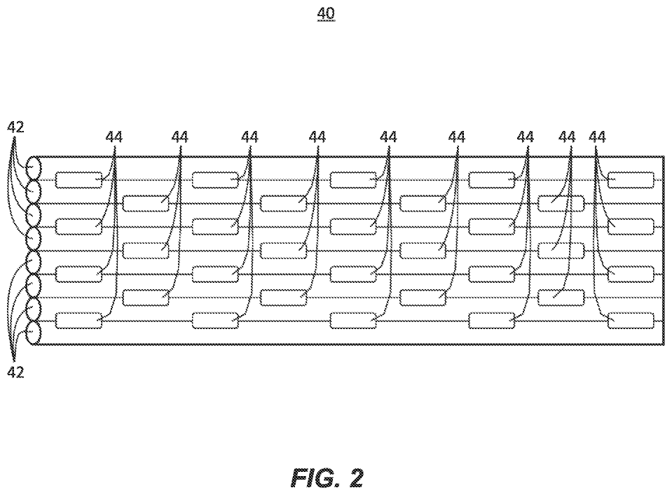

FIG. 2 is a top view of an 8-fiber partially bonded optical fiber ribbon or rollable ribbon 40. The optical fiber ribbon 40 includes a plurality of optical fibers 42 linearly arranged as a ribbon, with each optical fiber 42 having a fiber portion and a coating portion around the fiber portion. The optical fiber ribbon 40 also includes a plurality of bonding or ribbon matrix material portions 44, which are applied in a suitable manner and bond to various portions between adjacent optical fibers 42. As shown, the matrix material portions 44 can be applied in a staggered, uniform pattern across the optical fibers 42, however, the matrix material portions 44 are applied to the optical fibers 42 in such a manner that adjacent optical fibers 42 remain connected to one another, thus remaining an optical fiber ribbon, but also in a manner that allows the optical fiber ribbon 40 to be rolled and/or folded into one of a plurality of more densely configured unit shapes.

The matrix material portions 44 can be applied in a repeated pattern along adjacent optical fibers 42. According to embodiments of the invention, each matrix material portion 44 is between approximately 5 millimeters (mm) and approximately 20 millimeters (mm) in length. Also, according to embodiments of the invention, the distance between matrix material portions 44 along the same adjacent optical fibers 42, or pitch, is between approximately 20 millimeters (mm) and approximately 100 millimeters (mm). For example, according to an embodiment of the invention, the distance between matrix material portions 44 along the same adjacent optical fibers 42 (pitch) is approximately 40 millimeters (mm).

According to embodiments of the invention, the amount of matrix material used in a partially bonded optical fiber ribbon is between approximately 0.010 kilograms (kg) and approximately 0.030 kilograms (kg) per kilometer (km) of optical fiber ribbon. The amount of matrix material used in the partially bonded optical fiber ribbon depends on the distance between the matrix material portions 44 (pitch) and the length of each of the matrix material portions 44. According to an embodiment of the invention, for a partially bonded optical fiber ribbon having matrix material portions 44 that are between 5 and 20 mm in length, and spaced approximately 40 mm apart, the amount of matrix material used in the partially bonded optical fiber ribbon is approximately 0.024 kg per km of optical fiber ribbon.

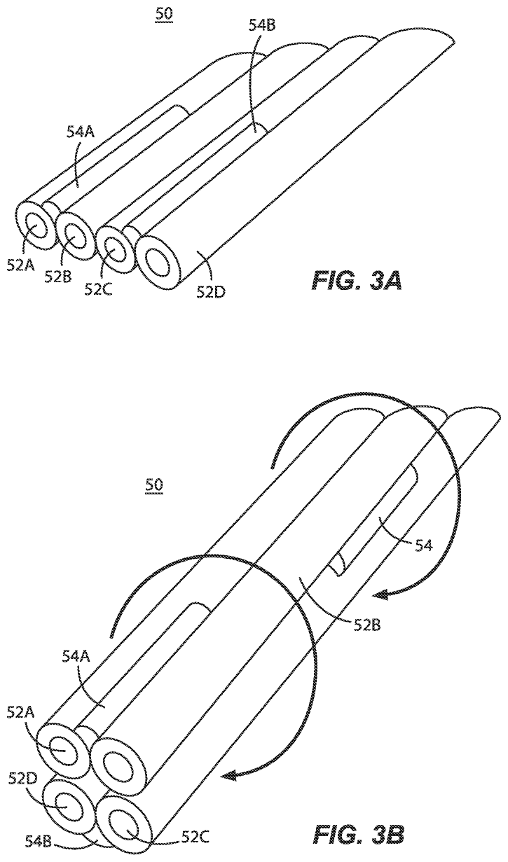

FIG. 3A is a perspective view of a partially bonded optical fiber ribbon or rollable optical fiber ribbon 50, prior to being rolled, according to embodiments of the invention. The optical fiber ribbon 50 includes a plurality of optical fibers 52, e.g., optical fibers 52A-D, for a 4-fiber rollable optical fiber ribbon. Prior to being rolled, the optical fibers 52A-D in the optical fiber ribbon 50 exist as a linear array of partially bonded optical fibers. The optical fiber ribbon 50 also includes a plurality of bonding or ribbon matrix material portions 54, e.g., matrix material portions 54A-B, which are applied in a suitable manner and bond to various portions between adjacent optical fibers 52.

FIG. 3B is a perspective view of the optical fiber ribbon 50 of FIG. 3A, after being rolled, according to embodiments of the invention. As shown, the optical fibers 52A-D are rolled and/or folded into a more densely configured unit shape, e.g., in a generally circular shape, as shown. As discussed hereinabove, because of the specific structure of the rollable optical fiber ribbon 50, e.g., being a partially bonded optical fiber ribbon or an optical fiber ribbon having other suitable structure, the rollable optical fiber ribbon 50 is able to be rolled and/or folded into a more densely configured unit shape.

Conventionally, the material used for the bonding or ribbon matrix portions can be any suitable material that bonds together a linear array of optical fibers into an optical fiber ribbon, and that includes the properties described hereinabove. For example, the bonding matrix material can be any suitable ultraviolet curable resin, thermosetting resin, thermoplastic resin, or other suitable bonding matrix material. Also, conventionally, the bonding matrix material typically has a Young's modulus within the range of approximately 40-600 Megapascals (MPa) or newton/millimeter² (N/mm²).

As discussed hereinabove, with conventional partially-bonded or rollable optical fiber ribbons, the lack of a uniform bonding or ribbon matrix material fully covering the entire portion of each optical fiber can cause one or more of the optical fibers to be relatively sensitive to optical signal transmission losses. Moreover, the relative high Young's modulus of the bonding or ribbon matrix material further contributes to the optical signal transmission losses.

According to embodiments of the invention, partially-bonded or rollable optical fiber ribbons include bonding or ribbon matrix material portions that have a relatively low Young's modulus, e.g., a Young's modulus of approximately 0.2 MPa. The partially bonded or rollable optical fiber ribbon includes two or more optical fibers arranged adjacent to one another in a linear array and bonding or ribbon matrix material applied to at least a portion of the outer surface of at least two adjacent optical fibers, in which the bonding or ribbon matrix material has a relatively low Young's modulus. According to embodiments of the invention, the relatively low Young's modulus matrix material portions induce less external stress on the optical fibers to which the matrix material portions are bonded, thus reducing the effect that the matrix material has on optical signal transmission losses of the optical fibers.

According to an embodiment of the invention, the bonding or ribbon matrix material can be any suitable material that bonds together a linear array of optical fibers into an optical fiber ribbon, and that has a relatively low Young's modulus, e.g., within a range of approximately 0.1-30 Megapascals (MPa) or newton/millimeter² (N/mm²). For example, the bonding or ribbon matrix material can be any suitable ultraviolet curable resin, thermosetting resin, thermoplastic resin, epoxy resin, or other suitable bonding or ribbon matrix material that has a relatively low Young's modulus, e.g., within a range of approximately 0.1-30 MPa.

A bonding or ribbon matrix material typically consists of four components: (1) an oligomer (approximately 50-70% of total volume) to control Young's modulus and sometimes to control viscosity, (2) a monomer (approximately 15-40% of total volume) to control viscosity and sometimes to control Young's modulus, (3) a release or slickness agent (approximately 1-10% of total volume) to ease peeling or prevent sticking, and (4) a photoinitiator (approximately 1-6% of total volume) to promote curing and/or to make all of the ingredients react and/or mix with each other. According to an embodiment of the invention, an oligomer is used that results in a lower Young's modulus of the bonding or ribbon matrix material compared to that of conventional bonding or ribbon matrix material.

Depending on what type of oligomer is used in the bonding or ribbon matrix material, adjusting the amount of the particular oligomer as a percentage of the total volume of the bonding or ribbon matrix material can either increase or decrease the Young's modulus of the bonding or ribbon matrix material. For example, for an oligomer that has a relatively low Young's modulus value compared to other oligomers, increasing the amount of the relatively low Young's modulus oligomer as a percentage of the total volume of the bonding or ribbon matrix material decreases the overall Young's modulus of the bonding or ribbon matrix material. According to an embodiment of the invention, a relatively low Young's modulus oligomer is used in a suitable amount as a percentage of the total volume of the bonding or ribbon matrix material that results in a lower Young's modulus of the bonding or ribbon matrix material compared to that of conventional bonding or ribbon matrix material.

Also, the amount of curing of the bonding or ribbon matrix material can affect the Young's modulus of the bonding or ribbon matrix material. Typically, more curing (e.g., higher curing powers and/or longer curing times) results in a higher Young's modulus of the bonding or ribbon matrix material. According to an embodiment of the invention, the bonding or ribbon matrix material is cured in a manner that results in a lower Young's modulus of the bonding or ribbon matrix material compared to that of conventional bonding or ribbon matrix material.

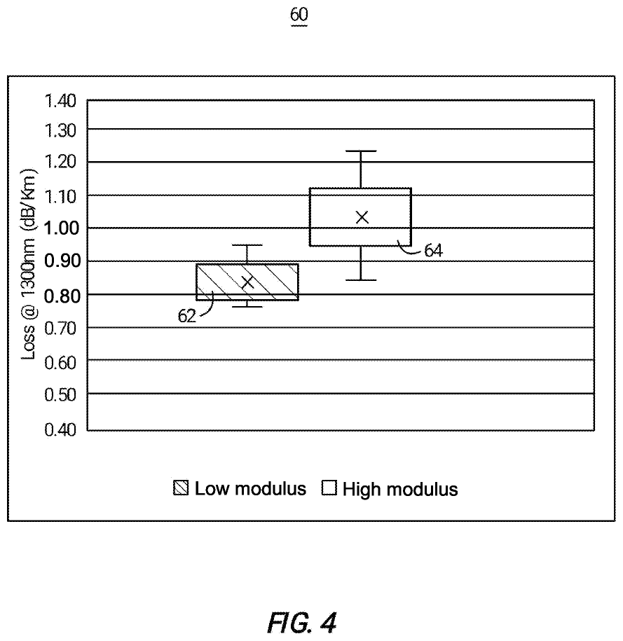

FIG. 4 is a graph 60 of transmission losses on a ribbon spool for a partially bonded or rollable optical fiber ribbon having a relatively low Young's modulus matrix material according to embodiments of the invention and for a partially bonded or rollable optical fiber ribbon having a conventional, relatively high Young's modulus matrix material. The transmission losses for a partially bonded or rollable optical fiber ribbon having a relatively low Young's modulus matrix material according to embodiments of the invention are shown generally as losses 62. The transmission losses for a partially bonded or rollable optical fiber ribbon having a conventional, relatively high Young's modulus matrix material are shown generally as losses 64. The transmission losses for each optical fiber ribbon are measured in decibels per kilometer of fiber (dB/km) for optical transmission at 1300 nanometers (nm).

As shown in the graph 60, the losses 62 for a partially bonded or rollable optical fiber ribbon having a relatively low Young's modulus matrix material are between approximately 0.78 dB/km and approximately 0.96 dB/km. By comparison, the losses 64 for a partially bonded or rollable optical fiber ribbon having a conventional, relatively high Young's modulus matrix material are between approximately 0.85 dB/km and approximately 1.24 dB/km. Therefore, for a partially bonded or rollable optical fiber ribbon produced on a ribbon spool, the use of a relatively low Young's modulus matrix material for partially bonding the optical fiber ribbon results in lower optical transmission losses than does the use of a relatively high Young's modulus matrix material for partially bonding the optical fiber ribbon.

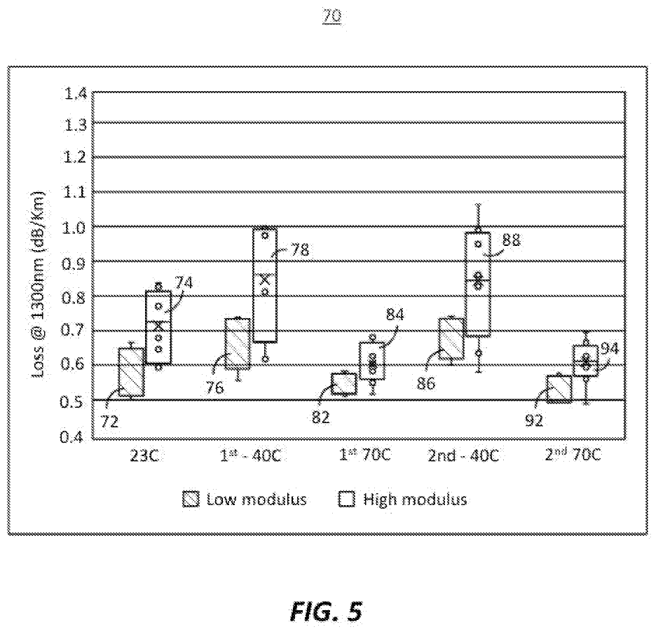

FIG. 5 is a graph 70 of transmission losses for a partially bonded or rollable optical fiber ribbon having a relatively low Young's modulus matrix material according to embodiments of the invention, after being cabled, and for a partially bonded or rollable optical fiber ribbon having a conventional, relatively high Young's modulus matrix material, after being cabled. The losses are shown for various temperatures, e.g., 23 degrees Celsius (° C.), −40° C. and 70° C. The losses for each optical fiber ribbon are measured in decibels per kilometer of fiber (dB/km) for optical transmission at 1300 nanometers (nm).

The losses for a partially bonded or rollable optical fiber ribbon having a relatively low Young's modulus matrix material according to embodiments of the invention are shown generally as losses 72 (at 23° C.), losses 76 and 86 (at −40° C.) and losses 82 and 92 (at 70° C.). The losses for a partially bonded or rollable optical fiber ribbon having a conventional, relatively high Young's modulus matrix material are shown generally as losses 74 (at 23° C.), losses 78 and 88 (at −40° C.) and losses 84 and 94 (at 70° C.).

As shown in the graph 70, the losses 72 for a partially bonded or rollable optical fiber ribbon having a relatively low Young's modulus matrix material, at 23° C., are between approximately 0.51 dB/km and approximately 0.65 dB/km. By comparison, the ribbon losses 74 for a partially bonded or rollable optical fiber ribbon having a conventional, relatively high Young's modulus matrix material, at 23° C., are between approximately 0.61 dB/km and approximately 0.81 dB/km.

At −40° C., the losses 76, 86 for a partially bonded or rollable optical fiber ribbon having a relatively low Young's modulus matrix material are between approximately 0.59 dB/km and approximately 0.74 dB/km (first measurement) and between approximately 0.62 dB/km and approximately 0.74 dB/km (second measurement). By comparison, at −40° C., the losses 78, 88 for a partially bonded or rollable optical fiber ribbon having a conventional, relatively high Young's modulus matrix material are between approximately 0.67 dB/km and approximately 0.99 dB/km (first measurement) and between approximately 0.69 dB/km and approximately 0.98 dB/km (second measurement).

At 70° C., the losses 82, 92 for a partially bonded or rollable optical fiber ribbon having a relatively low Young's modulus matrix material are between approximately 0.52 dB/km and approximately 0.57 dB/km (first measurement) and between approximately 0.50 dB/km and approximately 0.56 dB/km (second measurement). By comparison, at 70° C., the losses 84, 94 for a partially bonded or rollable optical fiber ribbon having a conventional, relatively high Young's modulus matrix material are between approximately 0.56 dB/km and approximately 0.67 dB/km (first measurement) and between approximately 0.58 dB/km and approximately 0.65 dB/km (second measurement).

Accordingly, for a cabled partially bonded or rollable optical fiber ribbon, the use of a relatively low Young's modulus matrix material for partially bonding the optical fiber ribbon results in lower optical transmission losses than does the use of a relatively high Young's modulus matrix material for partially bonding the optical fiber ribbon. Furthermore, the lower optical transmission losses for a cabled partially bonded or rollable optical fiber ribbon having a relatively low Young's modulus matrix material compared to a cabled partially bonded or rollable optical fiber ribbon having a relatively high Young's modulus matrix material occurs consistently across several different temperatures.

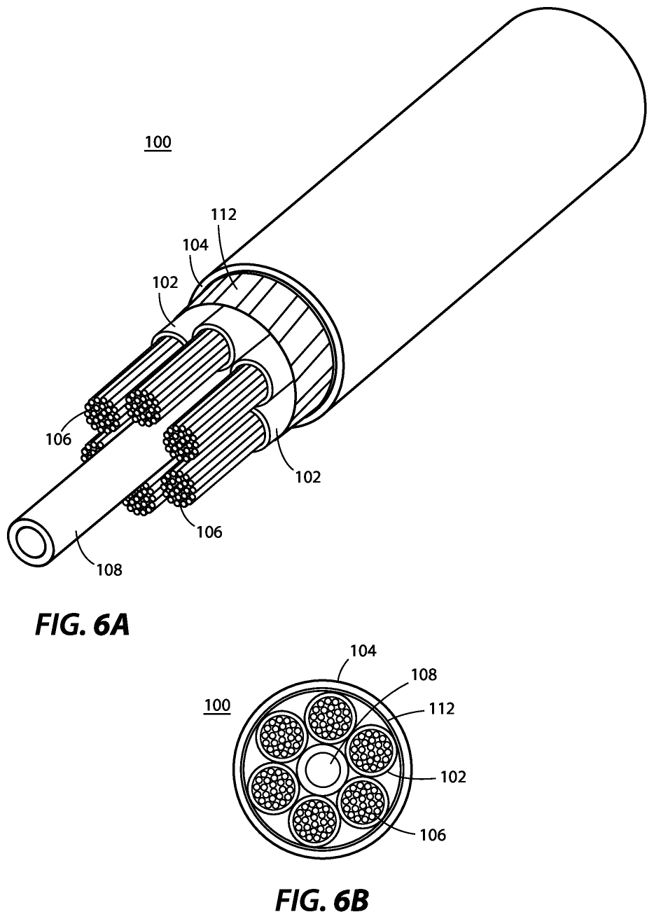

FIG. 6 is a perspective view of an optical fiber cable or loose-tube cable structure 100 having partially bonded optical fiber ribbons integrated therein, according to embodiments of the invention. According to embodiments of the invention, the partially bonded optical fiber ribbons include intermittently applied bonding matrix material portions having a relatively low Young's modulus, e.g., approximately 0.2 MPa or N/mm².

The cable structure 100 includes a plurality of multi-fiber unit tubes or loose tubes 102 positioned within a cable jacket 104. Each of the multi-fiber unit tubes 102 are substantially circular and dimensioned to receive therein a plurality of partially bonded optical fiber ribbons 106. The plurality of multi-fiber unit tubes 102 can be positioned around a central strength member 108. Alternatively, a second plurality of multi-fiber unit tubes (not shown) can be positioned around the first plurality of multi-fiber unit tubes 102.

The cable structure 100 can include a layer 112 of reinforcing strength yarns (e.g., aramid or fiberglass) between the cable jacket 104 and the multi-fiber unit tubes 102. Also, the cable structure 100 can include a superabsorbent tape (not shown) between the cable jacket 104 and the multi-fiber unit tubes 102.

The multi-fiber unit tubes 102 can be made of any suitable material. For example, the multi-fiber unit tubes 102 can be made of polypropylene, polybutylene terephthalate (PBT), polyethylene, nylon, polycarbonate, thermoplastic polyurethane (TPU), poly(vinyl chloride) (PVC) or other suitable material or materials. Flame retardant additives may be incorporated into the multi-fiber tubes 102 to help impart fire resistance. The multi-fiber unit tubes 102 can be a homogeneous tube, or can be multi-layer tubes produced by coextrusion.

The jacket 104 can be made of any suitable material. For example, the jacket 104 can be made of polyethylene, thermoplastic polyurethane, nylon 12, or other suitable material. Flame-retardant additives may be incorporated into the jacket 104 in order to impart fire resistance.

As shown in FIG. 6, the plurality of multi-fiber unit tubes 102 can be positioned within the jacket 104 as a first (inner) plurality of multi-fiber unit tubes 102 generally positioned around the central strength member 108 in a manner that forms a substantially circular cross-section. Alternatively, and a second (outer) plurality of multi-fiber unit tubes (not shown) can be generally positioned around the first plurality of multi-fiber unit tubes 102 in a manner that forms a substantially circular cross-section.

According to embodiments of the invention, the cable structure 100 can include between 72 to 3456 total optical fibers. For example, a 72-fiber cable structure includes six multi-fiber unit tubes 102, with each multi-fiber unit tube 102 having a 12-fiber partially bonded optical fiber ribbon. According to an embodiment of the invention, the cable structure 100 includes 144 optical fibers, i.e., twelve multi-fiber unit tubes 102 each having a 12-fiber partially bonded optical fiber ribbon therein.

It will be apparent to those skilled in the art that many changes and substitutions can be made to the embodiments of the invention herein described without departing from the spirit and scope of the invention as defined by the appended claims and their full scope of equivalents.

1. A partially bonded optical fiber ribbon, comprising:
a plurality of optical fibers arranged adjacent to one another in a linear array; and
a plurality of bonding matrix material portions applied to at least a portion of the outer surface of at least two adjacent optical fibers,
wherein the bonding matrix material portions have a low Young's modulus, and
wherein the plurality of bonding matrix material portions are applied to at least a portion of the outer surface of at least two adjacent optical fibers in such a way that the linear array of optical fibers forms a partially bonded optical fiber ribbon.

2. The optical fiber ribbon as recited in claim 1, wherein the Young's modulus of the plurality of bonding matrix material portions is within the range of approximately 0.1 Megapascals (MPa) to approximately 30 MPa.

3. The optical fiber ribbon as recited in claim 1, wherein the Young's modulus of the plurality of bonding matrix material portions is approximately 0.2 Megapascals (MPa) to approximately 30 MPa.

4. The optical fiber ribbon as recited in claim 1, wherein the bonding matrix material includes an oligomer to control the Young's modulus of the bonding matrix material.

5. The optical fiber ribbon as recited in claim 4, wherein the oligomer is within the range of approximately 50 percent to approximately 70 percent of the total volume of the bonding matrix material.

6. The optical fiber ribbon as recited in claim 1, wherein the bonding matrix material includes a monomer to control the Young's modulus of the bonding matrix material.

7. The optical fiber ribbon as recited in claim 1, wherein the bonding matrix material portions are between approximately 5 millimeters (mm) and approximately 20 millimeters (mm) in length.

8. The optical fiber ribbon as recited in claim 1, wherein the distance between the bonding matrix material portions along the same two adjacent optical fibers is between approximately 20 millimeters (mm) and approximately 20 millimeters (mm).

9. The optical fiber ribbon as recited in claim 1, wherein the distance between the bonding matrix material portions along the same two adjacent optical fibers is approximately 40 millimeters (mm).

10. The optical fiber ribbon as recited in claim 1, wherein the optical fiber ribbon has between approximately 0.010 and approximately 0.030 kilograms (kg) of bonding matrix material per kilometer (km) of optical fiber ribbon.

11. The optical fiber ribbon as recited in claim 1, wherein the optical fiber ribbon has approximately 0.024 kilograms (kg) of bonding matrix material per kilometer (km) of optical fiber ribbon.

12. The optical fiber ribbon as recited in claim 1, wherein the bonding matrix material is an ultraviolet curable resin, a thermosetting resin, a thermoplastic resin or an epoxy resin.

13. An optical fiber cable, comprising:
a plurality of multi-fiber unit tubes, wherein the multi-fiber unit tubes are substantially circular and dimensioned to receive a plurality of optical fibers; and
a plurality of partially bonded optical fiber ribbons positioned within at least one of the multi-fiber tubes, wherein the partially bonded optical fiber ribbons are partially bonded using a plurality of bonding matrix material portions applied to at least a portion of the outer surface of at least two adjacent optical fibers, wherein the bonding matrix material portions have a low Young's modulus; and
a jacket surrounding the plurality of multi-fiber unit tubes.

14. The optical fiber cable as recited in claim 13, wherein the Young's modulus of the plurality of bonding matrix material portions is approximately 0.2 Megapascals (MPa) to approximately 30 MPa.

15. The optical fiber cable as recited in claim 13, wherein the bonding matrix material includes an oligomer to control the Young's modulus of the bonding matrix material.

16. The optical fiber cable as recited in claim 15, wherein the oligomer is within the range of approximately 50 percent to approximately 70 percent of the total volume of the bonding matrix material.

17. The optical fiber cable as recited in claim 13, wherein the bonding matrix material includes a monomer to control the Young's modulus of the bonding matrix material.

18. The optical fiber cable as recited in claim 13, wherein the optical fiber ribbon has approximately 0.024 kilograms (kg) of bonding matrix material per kilometer (km) of optical fiber ribbon.

19. The optical fiber cable as recited in claim 13, wherein the plurality of multi-fiber unit tubes further comprises twelve multi-fiber unit tubes, and wherein each of the twelve multi-fiber unit tubes includes a 12-fiber partially bonded optical fiber ribbon.

20. The optical fiber cable as recited in claim 13, wherein at least one of the partially bonded optical fiber ribbons is bonded in such a way that the optical fiber ribbon is rolled into a substantially circular shape.
